(19) United States
(12) Patent Application Publication
(10) Pub. No.: US 2026/0362231 A1
(43) Pub. Date: Nov. 12, 2026

(54) REPORTING OF DELAY STATUS REPORT

(71) Applicant: LENOVO (BEIJING) LIMITED, Beijing (CN)

(72) Inventors: Mingzeng DAI, Beijing (CN); Xiaoying XU, Beijing (CN); Jing HAN, Beijing (CN); Lianhai WU, Beijing (CN)

(21) Appl. No.: 19/470,272

(22) PCT Filed: Sep. 28, 2023
(86) PCT No.: PCT/CN2023/122632

§ 371 Date: Sep. 29, 2025

(51) Int. Cl. H04W 28/02; H04L 69/322; H04W 76/15

(52) U.S. Cl. CPC H04W 28/0278; H04L 69/322; H04W 76/15

(57) ABSTRACT

Various aspects of the present disclosure relate to reporting of a DSR. In one aspect, a UE receive, from a base station, at least one remaining time threshold for triggering reporting of at least one DSR. The UE triggers the reporting of the at least one DSR based on the at least one remaining time threshold. In turn, the UE transmits a first DSR among the at least one DSR to a base station. The first DSR at least comprises a first sum of a first data volume of a first set of packets in a PDCP entity of the UE and a second data volume of a second set of packets in an RLC entity of the UE. Remaining time of the first set of packets and the second set of packets is less than or equal to one of the at least one remaining time threshold, and the remaining time is associated with a PDCP discard timer.

### TECHNICAL FIELD

The present disclosure relates to wireless communications, and more specifically to user equipment (UE), base station and methods for supporting reporting of a delay status report (DSR).

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as UE, or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A DSR reporting procedure may be used to provide a base station with delay status of uplink (UL) data. This delay status may comprise remaining time (RT) of UL data, which is based on a value of its associated timer at the time of the first symbol of the physical uplink control channel (PUSCH) transmission in which the DSR is transmitted. The DSR reporting procedure may be also used to provide the base station with the amount of UL data associated with the reported remaining time. The DSR reporting may improve the UL scheduling.

### SUMMARY

The present disclosure relates to UE, base station and methods that support reporting of a DSR. With the UE, base station and methods, during calculation of remaining time, packets in a radio link control (RLC) entity are considered and a data volume of these packets is included in the DSR. Therefore, the data volume in the DSR is accurate.

Some implementations of a UE described herein may include a processor and a transceiver coupled to the processor, wherein the processor is configured to: receive, via the transceiver from a base station, at least one remaining time threshold for triggering reporting of at least one DSR; trigger the reporting of the at least one DSR based on the at least one remaining time threshold; and transmit a first DSR among the at least one DSR via the transceiver to the base station, wherein the first DSR at least comprises a first sum of a first data volume of a first set of packets in a packet data convergence protocol (PDCP) entity of the UE and a second data volume of a second set of packets in an RLC entity of the UE, remaining time of the first set of packets and the second set of packets is less than or equal to one of the at least one remaining time threshold, and the remaining time is associated with PDCP discard timer.

In some implementations, the first set of packets comprises at least one of the following: PDCP service data units (SDUs) for which no PDCP protocol data units (PDUs) have been constructed, remaining time of which are less than or equal to a first remaining time threshold among the at least one remaining time threshold, or PDCP PDUs that have not been submitted to lower layers of the PDCP entity, remaining time of which are less than or equal to the first remaining time threshold. The second set of packets comprises at least one of the following: RLC SDUs and RLC SDU segments that have not been included in an RLC PDU, remaining time of which are less than or equal to the first remaining time threshold, RLC PDUs that are pending for initial transmission, remaining time of which are less than or equal to the first remaining time threshold, or RLC PDUs that are pending for retransmission, remaining time of which are less than or equal to the first remaining time threshold.

In some implementations, the processor is configured to trigger the reporting of the first DSR by: based on determining that remaining time of a third set of packets is less than or equal to the one of the at least one remaining time threshold, triggering the reporting of the first DSR, wherein the third set of packets at least comprises the first set of packets and the second set of packets.

In some implementations, the remaining time of the third set of packets is the smallest among remaining time of the packets in the third set of packets.

In some implementations, the third set of packets comprises at least one of the following: PDCP SDUs for which no PDCP PDUs have been constructed, PDCP PDUs that have not been submitted to lower layers of the PDCP entity, RLC SDUs and RLC SDU segments that have not been included in an RLC PDU, RLC PDUs that are pending for initial transmission, or RLC PDUs that are pending for retransmission.

In some implementations, the processor is configured to trigger the reporting of the first DSR by the PDCP entity. The processor is further configured to: provide the first data volume of the first set of packets from the PDCP entity to a MAC entity of the UE; and provide the second data volume of the second set of packets from the RLC entity to the MAC entity.

In some implementations, the processor is further configured to provide, from the PDCP entity to at least one of the RLC entity or the MAC entity, an indication indicating that the reporting of the first DSR is triggered.

In some implementations, the processor is further configured to: receive, via the transceiver from the base station, an indication indicating that all protocol data units (PDUs) in a PDU Set are to be discarded if any of the PDUs is not transmitted to the base station successfully. The first sum comprises a data volume of all the PDUs in the PDU Set to be transmitted if remaining time of any of the PDUs in the PDU Set is less than or equal to the one of the at least one remaining time threshold.

In some implementations, the at least one remaining time threshold at least comprises a first remaining time threshold and a second remaining time threshold which is greater than the first remaining time threshold. The processor is configured to trigger the reporting of the first DSR by one of the PDCP entity, the RLC entity or a MAC entity of the UE. The processor is further configured to: provide the first data volume of the first set of packets and a third data volume of a third set of packets in the PDCP entity from the PDCP entity to the MAC entity, wherein remaining time of the first set of packets is less than or equal to the first remaining time threshold, remaining time of the third set of packets is greater than the first remaining time threshold and less than or equal to the second remaining time threshold; and provide the second data volume of the second set of packets and a fourth data volume of a fourth set of packets in the RLC entity from the RLC entity to the MAC entity, wherein remaining time of the second set of packets is less than or equal to the first remaining time threshold, remaining time of the fourth set of packets is greater than the first remaining time threshold and less than or equal to the second remaining time threshold. The first DSR comprises the first sum of the first data volume and the second data volume as well as a second sum of the third data volume and the fourth data volume.

In some implementations, the processor is configured to trigger the reporting of the first DSR by a MAC entity of the UE.

In some implementations, the processor is further configured to: receive, via the transceiver from the base station, an indication indicating that all PDUs in a PDU Set are to be discarded if any of the PDUs is not transmitted to the base station successfully. The third set of packets comprise a PDCP SDU which is first arrived at the PDCP entity and has been transmitted to the base station successfully or has been submitted to a MAC entity of the UE, wherein a PDU associated with the PDCP SDU is comprised in the PDU Set if any of the PDUs in the PDU Set belongs to the first set of packets or the second set of packets.

In some implementations, the processor is configured to trigger the reporting of the first DSR by: based on determining that remaining time of the first set of packets is less than or equal to the one of the at least one remaining time threshold, triggering the reporting of the first DSR by the PDCP entity; based on determining that remaining time of the second set of packets is less than or equal to the one of the at least one remaining time threshold, triggering reporting of a second DSR among the at least one DSR by the RLC entity. The processor is further configured to: provide the first data volume of the first set of packets from the PDCP entity to a MAC entity of the UE; and provide the second data volume of the second set of packets from the RLC entity to the MAC entity.

In some implementations, the at least one remaining time threshold comprises a first remaining time threshold associated with a value of PDU Set Importance (PSI); and the processor is configured to trigger the reporting of the first DSR by: based on determining that remaining time of at least one PDU Set with the value of PSI is less than or equal to the first remaining time threshold, triggering the reporting of the first DSR, wherein the at least one PDU Set is comprised in the third set of packets.

In some implementations, the first sum comprises a data volume of the at least one PDU Set with the value of PSI.

In some implementations, the processor is further configured to determine the first sum of the first data volume and the second data volume when the reporting of the first DSR is triggered or at the time of transmission of the first DSR.

In some implementations, the processor is further configured to provide a request for the first data volume from a MAC entity of the UE to the PDCP entity.

In some implementations, the processor is further configured to provide a request for the second data volume from a MAC entity of the UE to the RLC entity.

Some implementations of a base station described herein may include a processor and a transceiver coupled to the processor, wherein the processor is configured to: transmit, via the transceiver to a UE, at least one remaining time threshold for triggering reporting of at least one DSR; and receive, via the transceiver from the UE, a first DSR among the at least one DSR, wherein the first DSR at least comprises a first sum of a first data volume of a first set of packets in a PDCP entity of the UE and a second data volume of a second set of packets in an RLC entity of the UE, remaining time of the first set of packets and the second set of packets is less than or equal to one of at least one remaining time threshold, and the remaining time is associated with PDCP discard timer.

Some implementations of a method described herein may include: receiving, at a UE from a base station, at least one remaining time threshold for triggering reporting of at least one DSR; triggering the reporting of the at least one DSR based on the at least one remaining time threshold; and transmitting a first DSR among the at least one DSR to the base station, wherein the first DSR at least comprises a first sum of a first data volume of a first set of packets in a PDCP entity of the UE and a second data volume of a second set of packets in an RLC entity of the UE, remaining time of the first set of packets and the second set of packets is less than or equal to one of at least one remaining time threshold, and the remaining time is associated with PDCP discard timer.

Some implementations of a method described herein may include: transmitting, from a base station to a UE, at least one remaining time threshold for triggering reporting of at least one DSR; and receiving, from the UE, a first DSR among the at least one DSR, wherein the first DSR at least comprises a first sum of a first data volume of a first set of packets in a PDCP entity of the UE and a second data volume of a second set of packets in an RLC entity of the UE, remaining time of the first set of packets and the second set of packets is less than or equal to one of at least one remaining time threshold, and the remaining time is associated with PDCP discard timer.

Some implementations of a processor described herein may include at least one memory and a controller coupled with the at least one memory and configured to cause the controller to: receive, from a base station, at least one remaining time threshold for triggering reporting of at least one DSR; trigger the reporting of the at least one DSR based on the at least one remaining time threshold; and transmit a first DSR among the at least one DSR to the base station, wherein the first DSR at least comprises a first sum of a first data volume of a first set of packets in a PDCP entity of the UE and a second data volume of a second set of packets in an RLC entity of the UE, remaining time of the first set of packets and the second set of packets is less than or equal to one of at least one remaining time threshold, and the remaining time is associated with PDCP discard timer.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

FIG. 1 illustrates an example of a wireless communications system that supports reporting of a DSR in accordance with aspects of the present disclosure;

FIG. 2 illustrates a signaling diagram illustrating an example process that supports reporting of a DSR in accordance with aspects of the present disclosure;

FIG. 3 illustrates an example process that supports reporting of a DSR in accordance with aspects of the present disclosure;

FIG. 4 illustrates a signaling diagram illustrating an example process that supports reporting of a DSR in accordance with aspects of the present disclosure;

FIG. 5 illustrates an example process that supports reporting of a DSR in accordance with aspects of the present disclosure;

FIG. 6 illustrates a signaling diagram illustrating an example process that supports reporting of a DSR in accordance with aspects of the present disclosure;

FIG. 7 illustrates an example process that supports reporting of a DSR in accordance with aspects of the present disclosure;

FIG. 8 illustrates a signaling diagram illustrating an example process that supports reporting of a DSR in accordance with aspects of the present disclosure;

FIG. 9 illustrates a signaling diagram illustrating an example process that supports reporting of a DSR in accordance with aspects of the present disclosure;

FIG. 10 illustrates an example of a device that supports reporting of a DSR and discarding based on a synchronization transmission set in accordance with some aspects of the present disclosure; and

FIG. 11 illustrates an example of a processor that supports reporting of a DSR discarding based on a synchronization transmission set in accordance with aspects of the present disclosure; and

FIGS. 12 and 13 illustrate a flowchart of a method that supports reporting of a DSR in accordance with aspects of the present disclosure, respectively.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As described above, the DSR reporting procedure is used to provide a base station with a delay status of UL data. A new separate MAC CE for DSR reporting may be defined. For example, DSR reporting may not be coupled with buffer status report (BSR) reporting. In addition, a UE may support threshold based DSR reporting.

Existing PDCP discard mechanism causes that a UE calculates the remaining time and trigger the DSR erroneously for the reasons as discussed below.

It is agreed that the UE calculates the remaining time based on a value of a PDCP discard timer and DSR reporting is triggered when remaining delay of UL data is less than or equal to a threshold configured by a base station. The threshold may be configured per logical channel group (LCG).

However, a PDCP entity of the UE does not stop the PDCP discard timer and discard a PDCP service data unit (SDU) even though the PDCP SDU has been transmitted to the base station successfully. It is specified that when the discardTimer expires for a PDCP SDU, or the successful delivery of the PDCP SDU is confirmed by PDCP status report, the transmitting PDCP entity shall discard the PDCP SDU along with the corresponding PDCP Data PDU. If the corresponding PDCP Data PDU has already been submitted to lower layers, the discard is indicated to lower layers.

According to the above specification, the UE only discards the PDCP SDU when the PDCP discard timer expires and the successful delivery of a PDCP PDU is confirmed by PDCP status report. The UE shall not discard the PDCP SDU and stop the PDCP discard timer even though the PDCP SDU has been transmitted to the base station successfully.

Since a PDCP SDU that has been transmitted successfully is not discarded and corresponding PDCP discard timer is not stopped, the UE may calculate the remaining time and trigger the DSR erroneously.

Furthermore, how to handle packets to be transmitted or re-transmitted in a radio link control (RLC) entity of the UE for the remaining time calculation and data volume report needs to be solved.

Currently, the remaining delay calculation and DSR trigger are assumed to be performed at a PDCP entity of the UE. However, some packets may have been submitted to the RLC entity and these packets may be about to be transmitted or re-transmitted in the RLC entity. The remaining time and corresponding data volume of these data should also be considered in DSR. Otherwise, the data volume in DSR is not accurate. Thus, how to handle the packets to be transmitted or re-transmitted in the RLC entity for the remaining time calculation and data volume report needs to be solved.

In view of the above, the present disclosure provides a solution that supports reporting of a DSR. In this solution, a UE receive, from a base station, at least one remaining time threshold for triggering reporting of at least one DSR. The UE triggers the reporting of the at least one DSR based on the at least one remaining time threshold. In turn, the UE transmits a first DSR among the at least one DSR to a base station. The first DSR at least comprises a first sum of a first data volume of a first set of packets in a PDCP entity of the UE and a second data volume of a second set of packets in an RLC entity of the UE. Remaining time of the first set of packets and the second set of packets is less than or equal to one of the at least one remaining time threshold, and the remaining time is associated with a PDCP discard timer. With this solution, during the remaining time calculation, packets in the RLC entity are considered and a data volume of these packets is included in the DSR. Therefore, the data volume in the DSR is accurate.

Aspects of the present disclosure are described in the context of a wireless communications system.

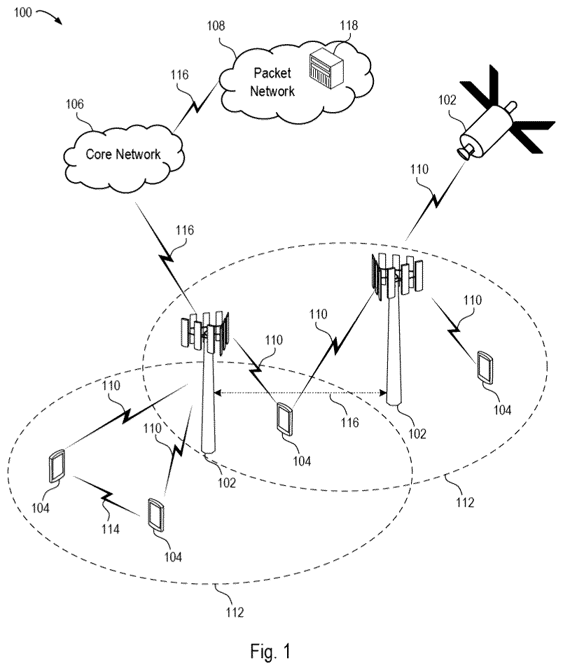

FIG. 1 illustrates an example of a wireless communications system 100 that supports reporting of a DSR in accordance with aspects of the present disclosure. The wireless communications system 100 may include one at least one of network entities 102 (also referred to as network equipment (NE)), one or more terminal devices or UEs 104, a core network 106, and a packet data network 108. The wireless communications system 100 may support various radio access technologies. In some implementations, the wireless communications system 100 may be a 4G network, such as an LTE network or an LTE-advanced (LTE-A) network. In some other implementations, the wireless communications system 100 may be a 5G network, such as an NR network. In other implementations, the wireless communications system 100 may be a combination of a 4G network and a 5G network, or other suitable radio access technology including institute of electrical and electronics engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The network entities 102 may be collectively referred to as network entities 102 or individually referred to as a network entity 102.

The network entities 102 may be dispersed throughout a geographic region to form the wireless communications system 100. One or more of the network entities 102 described herein may be or include or may be referred to as a network node, a base station (BS), a network element, a radio access network (RAN) node, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open radio access network (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN intelligent controller (RIC) (e.g., a near-real time RIC (Near-RT RIC), a non-real time RIC (Non-RT RIC)), a service management and orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), packet data convergence protocol (PDCP)). The CU may be connected to one or more DUs or RUS, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (510 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

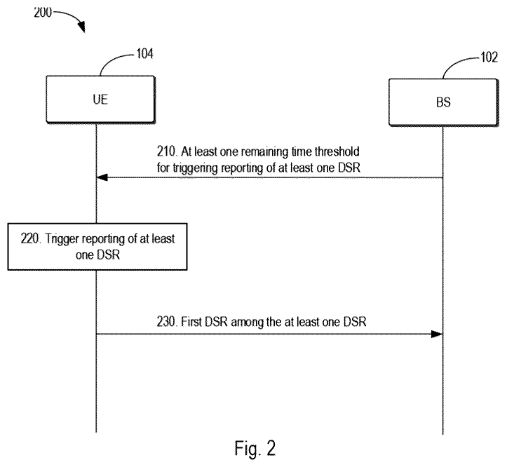

FIG. 2 illustrates a signaling diagram illustrating an example process 200 that supports reporting of a DSR in accordance with aspects of the present disclosure. The process 200 may involve the UE 104 and the base station 102 in FIG. 1. For the purpose of discussion, the process 200 will be described with reference to FIG. 1.

As shown in FIG. 2, the UE 104 receives 210, from the base station 102, at least one remaining time threshold for triggering reporting of at least one DSR.

In some implementations, the at least one remaining time threshold may be configured for triggering reporting of the at least one DSR for a data radio bearer (DRB) or for a LCG.

In some implementations, the at least one remaining time threshold may be configured by a radio resource control (RRC) message.

In turn, the UE 104 triggers 220 reporting of the at least one DSR based on the at least one remaining time threshold.

Then, the UE 104 transmits 230 a first DSR among the at least one DSR to the base station 102. The first DSR at least comprises a first sum of a first data volume of a first set of packets in a PDCP entity of the UE 104 and a second data volume of a second set of packets in an RLC entity of the UE 104. Remaining time of the first set of packets and the second set of packets is less than or equal to one of at least one remaining time threshold, and the remaining time is associated with a PDCP discard timer.

With the process 200, during the remaining time calculation, packets to be transmitted or re-transmitted in the RLC entity are considered and a data volume of these packets is included in the DSR. Therefore, the data volume in the DSR is accurate.

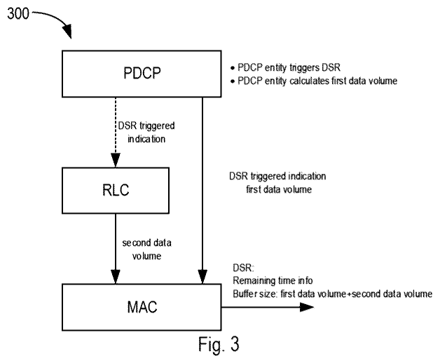

Hereinafter, some implementations of the process 200 will be described with reference to FIGS. 3 to 13.

FIG. 3 illustrates an example process 300 that supports reporting of a DSR in accordance with aspects of the present disclosure. The process 300 may be considered as an example implementation of the process 200. The process 300 may involve the UE 104 and the base station 102 in FIG. 1. For the purpose of discussion, the process 300 will be described with reference to FIG. 1.

In the process 300, the PDCP entity of the UE 104 triggers reporting of a DSR if remaining time of a third set of packets is less than or equal to a remaining time threshold. The third set of packets at least comprises the first set of packets and the second set of packets. The PDCP entity provides the first data volume of the first set of packets in the PDCP entity to the MAC entity. In addition, the PDCP entity may provide an indication to at least one of the RLC entity or the MAC entity. The indication indicates that the reporting of the DSR is triggered. Hereinafter, the indication is also referred to as a “DSR triggered indication” for brevity.

The RLC entity provides the second data volume of the second set of packets in the RLC entity to the MAC entity.

The MAC entity transmits a MAC control element (CE) for a DSR to the base station 102. Hereinafter, a MAC CE for a DSR is also referred to as a DSR MAC CE for brevity. The DSR MAC CE may comprise a first sum of the first data volume and the second data volume. For example, the DSR MAC CE may comprise a buffer size field which comprises the first sum of the first data volume and the second data volume. The DSR MAC CE may also comprise remaining time information associated with the first sum.

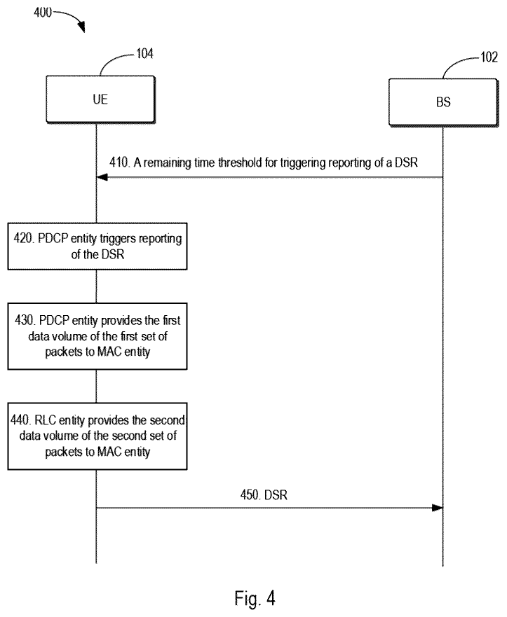

FIG. 4 illustrates a signaling diagram illustrating an example process 400 that supports reporting of a DSR in accordance with aspects of the present disclosure. The process 400 may be considered as an example implementation of the process 200 or 300. The process 400 may involve the UE 104 and the base station 102 in FIG. 1. For the purpose of discussion, the process 400 will be described with reference to FIG. 1.

As shown in FIG. 4, the UE 104 receives 410, from the base station 102, a remaining time threshold for triggering reporting of a DSR.

In some implementations, the remaining time threshold may be configured for triggering reporting of the DSR for a DRB or for an LCG.

In some implementations, the remaining time threshold may be configured by an RRC message.

If remaining time of a third set of packets is less than or equal to the remaining time threshold, the PDCP entity triggers 420 reporting of the DSR.

In some implementations, the remaining time of the third set of packets is the smallest or shortest among remaining time of the packets in the third set.

In some implementations, remaining time of a packet in the third set is associated with its associated PDCP discard timer. For example, the remaining time is a value of a PDCP discard timer (configured by RRC) minus the running time of the PDCP discard timer. The PDCP discard timer is started upon reception of a PDCP SDU associated with the packet from upper layer of the UE 104. Usually, the value of the PDCP discard timer is set according to packets delay budget (PDB) or PDU set delay budget (PSDB). When the PDCP discard timer expires, the UE 104 shall discard the PDCP SDU.

In some implementations, the third set of packets does not comprise any PDCP SDU which has been transmitted successfully to the base station 102. In such implementations, the third set of packets may comprise at least one of the following:
PDCP SDUs for which no PDCP PDUs have been constructed,
PDCP PDUs that have not been submitted to lower layers of the PDCP entity, or
RLC SDUs or PDUs that can be considered as RLC data volume, wherein the RLC data volume may be an amount of data available for transmission in the RLC entity.

Because the third set of packets does not comprise any PDCP SDU which has been transmitted successfully to the base station 102, the UE 104 will not trigger the DSR erroneously.

In some implementations, the RLC SDUs or PDUs that can be considered as RLC data volume may comprise at least one of the following:
RLC SDUs and RLC SDU segments that have not been included in an RLC PDU, wherein an RLC SDU segment may be a segment of an RLC SDU,
RLC PDUs that are pending for initial transmission, or
RLC PDUs that are pending for retransmission (RLC Acknowledged Mode (AM)).

In such implementations, during the remaining time calculation, packets to be transmitted or re-transmitted in the RLC entity are considered and a data volume of these packets is included in the DSR. Therefore, the data volume in the DSR is accurate.

In some implementations, the UE 104 may receive, from the base station 102, an indication indicating that all PDUs in a PDU Set are to be discarded if any of the PDUs is not transmitted to the base station successfully. The indication is also referred to as a pdu-SetDiscard indication. The pdu-SetDiscard indication may be configured when PDU Set integration is needed, i.e., all PDUs of the PDU Set are needed for the usage of the PDU Set by the application layer in the receiver side. In such implementations, the third set of packets may comprise a PDCP SDU of the PDU set which is first arrived at the PDCP entity and has been transmitted to the base station 102 successfully or has been submitted to the MAC entity, which means the remaining time of the first PDU of the PDU Set is taken into account for triggering the DSR reporting procedure if there is any PDU of the PDU set which is pending to be transmitted or re-transmitted in PDCP entity or RLC entity. A PDU of the PDU set associated with the PDCP SDU is comprised in the first set of packets if any of the PDUs in the PDU Set belongs to the first set of packets or the second set of packets.

The PDCP entity provides 430 the first data volume of the first set of packets in the PDCP entity to the MAC entity.

In some implementations, the PDCP entity may provide the first data volume of the first set of packets in the PDCP entity to the MAC entity when the reporting of the DSR is triggered or at the time of transmission of the DSR. For example, the PDCP entity may provide the first data volume in a sub-frame or slot in which the DSR is transmitted to the base station 102.

In some implementations, the PDCP entity may receive a request for the first data volume from the MAC entity. Upon receiving the request, the PDCP entity may provide the first data volume to the MAC entity.

In some implementations, the PDCP entity may also provide the DSR triggered indication to at least one of the RLC entity or the MAC entity.

In some implementations, the first set of packets may comprise at least one of the following:
PDCP SDUs for which no PDCP PDUs have been constructed, remaining time of which are less than or equal to a first remaining time threshold among the at least one remaining time threshold, or
PDCP PDUs that have not been submitted to lower layers of the PDCP entity, remaining time of which are less than or equal to the first remaining time threshold.

In some implementations, if the UE 104 receives the pdu-SetDiscard indication from the base station 102, the first set of packets may comprise the remaining PDUs of the PDU set if remaining time of any of PDUs in the PDU set is less than or equal to the remaining time threshold.

In some implementations, the PDCP entity may provide the remaining time of the third set of packets to the MAC entity.

The RLC entity provides 440 the second data volume of the second set of packets in the RLC entity to the MAC entity.

In some implementations, the RLC entity may provide the second data volume of the second set of packets in the RLC entity to the MAC entity when the reporting of the DSR is triggered or at the time of transmission of the DSR. For example, the RLC entity may provide the second data volume in a sub-frame or slot in which the DSR is transmitted to the base station 102.

In some implementations, the RLC entity may receive the DSR triggered indication from the PDCP entity. When receiving the DSR triggered indication, the RLC entity may provide the second data volume of the second set of packets in the RLC entity to the MAC entity.

In some implementations, the RLC entity may receive a request for the second data volume from the MAC entity. Upon receiving the request, the RLC entity may provide the second data volume to the MAC entity.

In some implementations, the second set of packets may comprise at least one of the following:
RLC SDUs and RLC SDU segments that have not been included in an RLC PDU, remaining time of which are less than or equal to the first remaining time threshold,
RLC PDUs that are pending for initial transmission, remaining time of which are less than or equal to the first remaining time threshold, or
RLC PDUs that are pending for retransmission, remaining time of which are less than or equal to the first remaining time threshold.

Consider an example of the first set of packets, the second set of packets and the third set of packets. In this example, a value of a PDCP discard timer value is equal to 50 ms. A remaining time threshold is equal to 15 ms.

The PDCP SDUs for which no PDCP PDUs have been constructed and the PDCP PDUs that have not been submitted to lower layers may comprise packet #1 (RT=10 ms) and packet #2 (RT=20 ms).

The RLC SDUs and RLC SDU segments that have not yet been included in an RLC PDU, the RLC PDUs that are pending for initial transmission and the RLC data PDUs that are pending for retransmission may comprise packet #3 (RT=12 ms) and packet #4 (RT=40 ms).

In this example, the third set of packets may comprise packet #1 (RT=10 ms), packet #2 (RT=20 ms), packet #3 (RT=12 ms), packet #4 (RT=40 ms). The first set of packets may comprise packet #1 (RT=10 ms), and the second set may comprise packet #3 (RT=12 ms).

With continued reference to FIG. 4, the MAC entity transmits 450 a DSR MAC CE to the base station 102. The DSR MAC CE may comprise the first sum of the first data volume and the second data volume. For example, the DSR MAC CE may comprise a buffer size field which comprises the first sum of the first data volume and the second data volume.

In some implementations, the first sum of the first data volume and the second data volume may be a total amount of the first data volume and the second data volume when the DSR is triggered.

Alternatively, in some implementations, the first sum of the first data volume and the second data volume may be a total amount of the first data volume and the second data volume at the time when the DSR is transmitted to the base station 102. For example, the first sum of the first data volume and the second data volume may be a total amount of the first data volume and the second data volume in a subframe or slot in which the DSR is transmitted to the base station 102.

In some implementations, if the UE 104 receives the pdu-SetDiscard indication from the base station 102, the first sum may comprise a data volume of all the PDUs in the PDU Set to be transmitted if remaining time of any of the PDUs in the PDU Set is less than or equal to the remaining time threshold.

In some implementations, the DSR MAC CE may also comprise remaining time of the third set of packets and the remaining time is associated with the first sum of the first data volume and the second data volume. The remaining time of the third set of packets is the smallest or shortest among remaining time of the packets in the third set.

In some implementations, the remaining time may be calculated when the DSR is triggered. In this case, the remaining time is indicated by the PDCP entity.

Alternatively, in some implementations, the remaining time may be calculated at the time of transmission of the DSR. For example, the remaining time may be calculated in a sub-frame or slot in which the DSR is transmitted to the base station 102. In such implementations, the MAC entity may need to re-calculate the remaining time. For example, the reported remaining time is the remaining time indicated by the PDCP entity minus the buffered time of the indicated remaining time in the MAC entity.

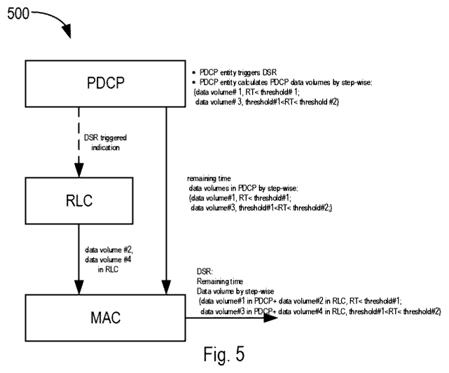

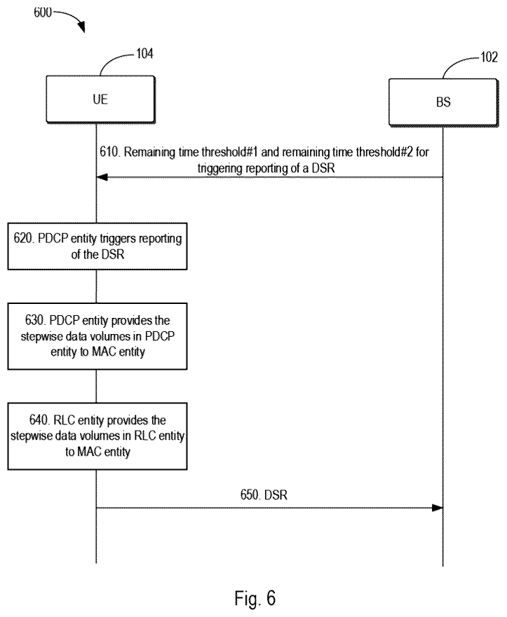

In some implementations, the UE 104 may report the DSR by stepwise method. In such implementations, the DSR may comprise data volumes for different remaining time thresholds. This will be described with reference to FIGS. 5 and 6.

FIG. 5 illustrates an example process 500 that supports reporting of a DSR in accordance with aspects of the present disclosure. The process 500 may be considered as an example implementation of the process 200. The process 500 may involve the UE 104 and the base station 102 in FIG. 1. For the purpose of discussion, the process 500 will be described with reference to FIG. 1.

In the process 500, the at least one remaining time threshold may at least comprise a first remaining time threshold (represented by a remaining time threshold #1) and a second remaining time threshold (represented by a remaining time threshold #2). The remaining time threshold #2 is greater than the remaining time threshold #1.

The PDCP entity of the UE 104 triggers reporting of a DSR if remaining time of the third set of packets is less than or equal to one of the remaining time threshold #1 and the remaining time threshold #2. The third set of packets at least comprises the first set of packets and the second set of packets.

The PDCP entity provides the stepwise data volumes in the PDCP entity to the MAC entity.

The RLC entity provides the stepwise data volumes in the RLC entity to the MAC entity.

The MAC entity transmits the DSR MAC CE to the base station 102. The DSR MAC CE as least comprises the total amount of the data volumes in the PDCP entity and the data volumes in the RLC entity by stepwise method.

FIG. 6 illustrates a signaling diagram illustrating an example process 600 that supports reporting of a DSR in accordance with aspects of the present disclosure. The process 600 may be considered as an example implementation of the process 200 or 500. The process 600 may involve the UE 104 and the base station 102 in FIG. 1. For the purpose of discussion, the process 600 will be described with reference to FIG. 1.

As shown in FIG. 6, the UE 106 receives 610, from the base station 102, the remaining time threshold #1 and the remaining time threshold #2 for triggering reporting of a DSR. For example, the remaining time threshold #1 may be equal to 5 ms and the remaining time threshold #2 may be equal to 10 ms. The remaining time threshold #1 and the remaining time threshold #2 may be defined as same as the single remaining time threshold in the processes 300 and 400.

In some implementations, the remaining time threshold #1 and the remaining time threshold #2 may be configured for triggering reporting of the DSR for a DRB or for an LCG.

In some implementations, the remaining time threshold #1 and the remaining time threshold #2 may be configured by an RRC message.

If remaining time of the third set of packets is less than or equal to one of the the remaining time threshold #1 and the remaining time threshold #2, the PDCP entity triggers 620 reporting of the DSR. The third set of packets may be defined as same as that in the processes 300 and 400.

In some implementations, the PDCP entity may provide a DSR triggered indication with corresponding remaining time threshold to the MAC entity.

For example, if the remaining time of the third set of packets is less than or equal to the remaining time threshold #2 but greater than the remaining time threshold #1, the PDCP entity provides, to the MAC entity, an indication indicating the DSR is triggered by the remaining time threshold #2. If the remaining time is less than or equal to the remaining time threshold #1, the PDCP entity provides, to the MAC entity, an indication indicating the DSR is triggered by the remaining time threshold #1 or triggered by both the remaining time threshold #1 and the remaining time threshold #2. Hereinafter, the indication is also referred to as a DSR triggered indication for brevity.

The PDCP entity provides 630 the stepwise data volumes in the PDCP entity to the MAC entity.

In some implementations, the PDCP entity may provide the stepwise data volumes in the PDCP entity to the MAC entity when the reporting of the DSR is triggered or at the time of transmission of the DSR. For example, the PDCP entity may provide the stepwise data volumes in the PDCP entity in a sub-frame or slot in which the DSR is transmitted to the base station 102.

In some implementations, the PDCP entity may receive a request for the stepwise data volumes in the PDCP entity from the MAC entity. Upon receiving the request, the PDCP entity may provide the stepwise data volumes in the PDCP entity to the MAC entity.

In some implementations, the stepwise data volumes in the PDCP entity may comprise a first data volume (represented by data volume #1) of a first set of packets and a third data volume (represented by data volume #3) of a third set of packets in the PDCP entity. Remaining time of the first set of packets is less than or equal to the remaining time threshold #1, and remaining time of the third set of packets is greater than the remaining time threshold #1 and less than or equal to the remaining time threshold #2. For example, the remaining time of the first set of packets is less than or equal to 5 ms, and the remaining time of the third set of packets may be between 5 ms and 10 ms.

In some implementations, the first set of packets may comprise at least one of the following:
PDCP SDUs for which no PDCP PDUs have been constructed, remaining time of which are less than or equal to the remaining time threshold #1, or
PDCP PDUs that have not been submitted to lower layers of the PDCP entity, remaining time of which are less than or equal to the remaining time threshold #1.

In some implementations, the third set of packets may comprise at least one of the following:
PDCP SDUs for which no PDCP PDUs have been constructed, remaining time of which are greater than the remaining time threshold #1 and less than or equal to the remaining time threshold #2, or
PDCP PDUs that have not been submitted to lower layers of the PDCP entity, remaining time of which are greater than the remaining time threshold #1 and less than or equal to the remaining time threshold #2.

In some implementations, if the UE 104 receives the pdu-SetDiscard indication from the base station 102, the first set of packets may comprise the remaining PDUs of the PDU set if remaining time of any of PDUs in the PDU set is less than or equal to the remaining time threshold #1.

In some implementations, the PDCP entity may provide the remaining time of the third set of packets to the MAC entity.

The RLC entity provides 640 the stepwise data volumes in the RLC entity to the MAC entity.

In some implementations, the RLC entity may provide the stepwise data volumes in the RLC entity to the MAC entity when the reporting of the DSR is triggered or at the time of transmission of the DSR. For example, the RLC entity may provide the stepwise data volumes in the RLC entity in a sub-frame or slot in which the DSR is transmitted to the base station 102.

In some implementations, the RLC entity may receive the DSR triggered indication from the PDCP entity. When receiving the DSR triggered indication, the RLC entity may provide the stepwise data volumes in the RLC entity to the MAC entity.

In some implementations, the RLC entity may receive a request for the stepwise data volumes in the RLC entity from the MAC entity. Upon receiving the request, the RLC entity may provide the stepwise data volumes in the RLC entity to the MAC entity.

In some implementations, the stepwise data volumes in the RLC entity may comprise a second data volume (represented by data volume #2) of a second set of packets and a fourth data volume (represented by data volume #4) of a fourth set of packets in the RLC entity. Remaining time of the second set of packets is less than or equal to the remaining time threshold #1, and remaining time of the fourth set of packets is greater than the remaining time threshold #1 and less than or equal to the remaining time threshold #2. For example, the remaining time of the second set of packets is less than or equal to 5 ms, and the remaining time of the fourth set of packets may be between 5 ms and 10 ms.

In some implementations, the second set of packets may comprise at least one of the following:
RLC SDUs and RLC SDU segments that have not been included in an RLC PDU, remaining time of which are less than or equal to the remaining time threshold #1,
RLC PDUs that are pending for initial transmission, remaining time of which are less than or equal to the remaining time threshold #1, or
RLC PDUs that are pending for retransmission, remaining time of which are less than or equal to the remaining time threshold #1.

In some implementations, the fourth set of packets may comprise at least one of the following:
RLC SDUs and RLC SDU segments that have not been included in an RLC PDU, remaining time of which are greater than the remaining time threshold #1 and less than or equal to the remaining time threshold #2,
RLC PDUs that are pending for initial transmission, remaining time of which are greater than the remaining time threshold #1 and less than or equal to the remaining time threshold #2, or
RLC PDUs that are pending for retransmission, remaining time of which are greater than the remaining time threshold #1 and less than or equal to the remaining time threshold #2.

The MAC entity transmits 650 a DSR MAC CE to the base station 102. The DSR MAC CE may comprise the first sum of the first data volume and the second data volume as well as a second sum of the third data volume and the fourth data volume. For example, the DSR MAC CE may comprise a buffer size field which comprises the first sum and the second sum.

In some implementations, the first sum may be a total amount of the data volume #1 in the PDCP entity and the data volume #3 in the RLC entity when the DSR is triggered. The second sum may be a total amount of the data volume #2 in the PDCP entity and the data volume #4 in the RCL entity when the DSR is triggered.

Alternatively, in some implementations, the first sum may be a total amount of the data volume #1 in the PDCP entity and the data volume #3 in the PDCP entity at the time when the DSR is transmitted to the base station 102. For example, the first sum may be a total amount of the data volume #1 in the PDCP entity and the data volume #3 in the RLC entity in a subframe or slot in which the DSR is transmitted to the base station 102. The second sum may be a total amount of the data volume #2 in the PDCP entity and the data volume #4 in the RLC entity at the time when the DSR is transmitted to the base station 102. For example, the second sum may be a total amount of the data volume #2 in the PDCP entity and the data volume #4 in the RLC entity in a subframe or slot in which the DSR is transmitted to the base station 102.

In some implementations, the DSR MAC CE may also comprise stepwise remaining time of the third set of packets.

In some implementations, the stepwise remaining time of the third set of packets is the smallest or shortest among remaining time of the packets in the third set.

Alternatively, in some implementations, the stepwise remaining time of the third set of packets may be the smallest among remaining time of the packets in the third set for each remaining time threshold. For example, the stepwise remaining time may comprise the smallest remaining time which is less than or equal to the remaining time threshold #1 and the smallest remaining time which is between the remaining time threshold #1 and the remaining time threshold #2.

In some implementations, the stepwise remaining time may be calculated when the DSR is triggered. In this case, the stepwise remaining time is indicated by the PDCP entity.

Alternatively, in some implementations, the stepwise remaining time may be calculated at the time of transmission of the DSR. For example, the stepwise remaining time may be calculated in a sub-frame or slot in which the DSR is transmitted to the base station 102. In such implementations, the MAC entity may need to re-calculate the stepwise remaining time. For example, the reported stepwise remaining time is the stepwise remaining time indicated by the PDCP entity minus the buffered time of the indicated stepwise remaining time in the MAC entity.

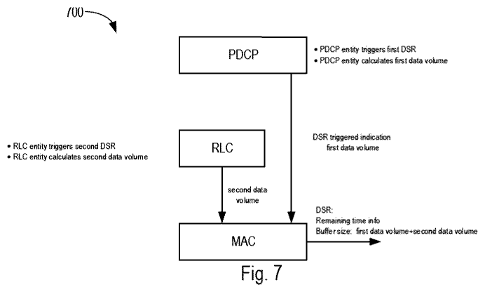

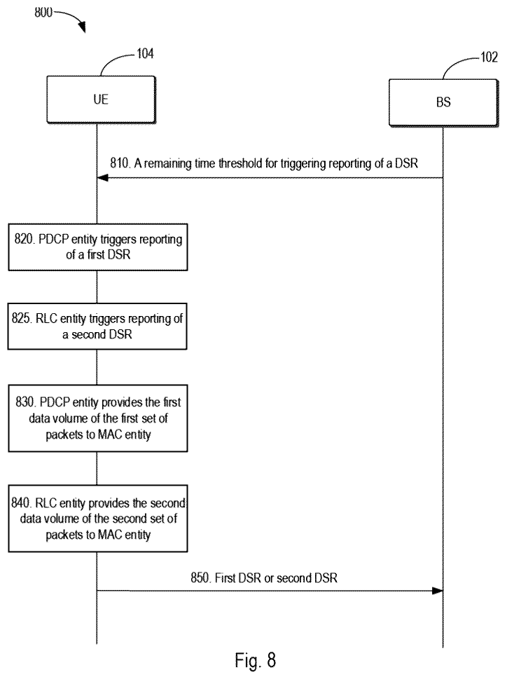

In some implementations, each of the PDCP entity and RLC entity may trigger a DSR independently. This will be described with reference to FIGS. 7 and 8.

FIG. 7 illustrates an example process 700 that supports reporting of a DSR in accordance with aspects of the present disclosure. The process 700 may be considered as an example implementation of the process 200. The process 700 may involve the UE 104 and the base station 102 in FIG. 1. For the purpose of discussion, the process 700 will be described with reference to FIG. 1.

In the process 700, each of the PDCP entity and RLC entity may trigger a DSR independently.

Specifically, the PDCP entity triggers a DSR if the remaining time of the first set of packets is less than or equal to a remaining time threshold.

The RLC entity triggers a second DSR if the remaining time of the second set of packets is less than or equal to the remaining time threshold.

The PDCP entity provides the first data volume of the first set of packets to the MAC entity.

The RLC entity provides the second data volume of the second set of packets to the MAC entity.

The MAC entity transmits the DSR MAC CE to the base station 102. The DSR MAC CE as least comprises the first sum of the first data volume and the second data volume.

FIG. 8 illustrates a signaling diagram illustrating an example process 800 that supports reporting of a DSR in accordance with aspects of the present disclosure. The process 800 may be considered as an example implementation of the process 200 or 700. The process 800 may involve the UE 104 and the base station 102 in FIG. 1. For the purpose of discussion, the process 800 will be described with reference to FIG. 1.

Actions 810, 830 and 840 in the process 800 are similar to actions 410, 430 and 440 in the process 400. Details of these actions are omitted for brevity.

The process 800 is different from the process 400 in actions 820, 825 and 850.

Specifically, if remaining time of the first set of packets is less than or equal to the one of the at least one remaining time threshold, the PDCP entity triggers 820 the reporting of a first DSR. The first set of packets is defined as same as that in the action 430 in the process 400.

If remaining time of the second set of packets is less than or equal to the one of the at least one remaining time threshold, the RLC entity triggers reporting of a second DSR. The second set of packets is defined as same as that in the action 440 in the process 400.

The MAC entity transmits 850 the first DSR or the second DSR to the base station 102. Each of the first DSR and the second DSR comprises a DSR MAC CE. The DSR MAC CE may comprise the first sum of the first data volume and the second data volume. Details of the DSR MAC CE may be the same as that described with respect to the action 450 in the process 400.

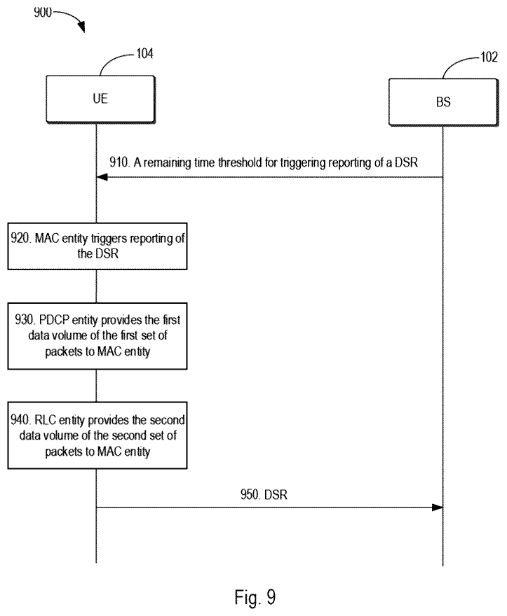

In some implementations, the MAC entity may trigger a DSR. This will be described with reference to FIG. 9.

FIG. 9 illustrates a signaling diagram illustrating an example process 900 that supports reporting of a DSR in accordance with aspects of the present disclosure. The process 900 may be considered as an example implementation of the process 200. The process 900 may involve the UE 104 and the base station 102 in FIG. 1. For the purpose of discussion, the process 900 will be described with reference to FIG. 1.

Actions 910, 930, 940 and 950 in the process 900 are similar to actions 410, 430, 440 and 450 in the process 400. Details of these actions are omitted for brevity.

The process 900 is different from the process 400 in an action 920.

Specifically, if remaining time of the third set of packets is less than or equal to the remaining time threshold, the MAC entity triggers 920 reporting of the DSR. The third set of packets is defined as same as that in any of the processes 300 to 800.

In some implementations, PDU sets with different values of PSI can be configured with different PDCP discard timers. PDU Set Importance (PSI) may be used to identify the relative importance of a PDU Set compared to other PDU Sets within a Quality of Service (QoS) Flow. In such implementations, per PSI based DSR may be applied.

In such implementations, the UE 104 receives the at least one remaining time threshold from the base station 102. The at least one remaining time threshold may comprise a first remaining time threshold associated with a value of PSI. In other words, the base station 102 may configure per PSI remaining time threshold.

In some implementations, the first remaining time threshold associated with the value of PSI may be configured for triggering reporting of a DSR for data with the value of PSI of a DRB or for an LCG.

In some implementations, the first remaining time threshold associated with the value of PSI may be configured by an RRC message.

In such implementations, if remaining time of at least one PDU Set with the value of PSI is less than or equal to the first remaining time threshold, the UE 104 triggers the reporting of the DSR. The at least one PDU Set is comprised in the third set of packets. The third set of packets may be defined as same as those in the process 400. In other words, in the third set of packets, there may be different sub-sets of packets with different values of PSI. During the calculation of the remaining time, the UE 104 may only consider the packets with the value of PSI associated with first remaining time threshold.

In turn, the UE 104 transmits the DSR to the base station 102. The DSR comprises the first sum of the first data volume of the first set of packets with the value of PSI and the second data volume of the second set of packets with the value of PSI. For example, The DSR comprises the first sum of the first data volume of the first set of packets with the value of PSI and the second data volume of the second set of packets with the value of PSI at the time when the DSR is transmitted.

In some implementations, the DSR may also comprise a PSI indication or bitmap to indicate whether the DSR comprises the data volume and/or remaining time for a value of PSI.

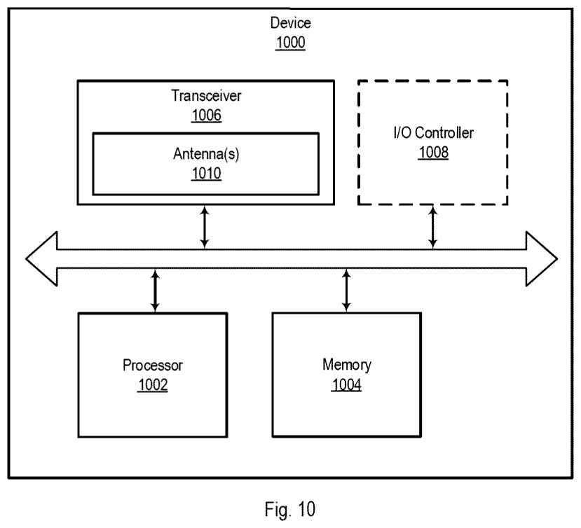

FIG. 10 illustrates an example of a device 1000 that supports delay report and discarding based on a synchronization transmission set in accordance with aspects of the present disclosure. The device 1000 may be an example of a base station 102 or a UE 104 as described herein. The device 1000 may support wireless communication with one or more network entities 102, UEs 104, or any combination thereof. The device 1000 may include components for bi-directional communications including components for transmitting and receiving communications, such as a processor 1002, a memory 1004, a transceiver 1006, and, optionally, an I/O controller 1008. These components may be in electronic communication or otherwise coupled (e.g., operatively, communicatively, functionally, electronically, electrically) via one or more interfaces (e.g., buses).

The processor 1002, the memory 1004, the transceiver 1006, or various combinations thereof or various components thereof may be examples of means for performing various aspects of the present disclosure as described herein. For example, the processor 1002, the memory 1004, the transceiver 1006, or various combinations or components thereof may support a method for performing one or more of the operations described herein.

In some implementations, the processor 1002, the memory 1004, the transceiver 1006, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1002 and the memory 1004 coupled with the processor 1002 may be configured to perform one or more of the functions described herein (e.g., executing, by the processor 1002, instructions stored in the memory 1004).

For example, the processor 1002 may support wireless communication at the device 1000 in accordance with examples as disclosed herein. The processor 1002 may be configured to operable to support a means for performing the following: receiving, at a UE from a base station, at least one remaining time threshold for triggering reporting of at least one DSR; triggering the reporting of the at least one DSR based on the at least one remaining time threshold; and transmitting a first DSR among the at least one DSR to the base station, wherein the first DSR at least comprises a first sum of a first data volume of a first set of packets in a PDCP entity of the UE and a second data volume of a second set of packets in an RLC entity of the UE, remaining time of the first set of packets and the second set of packets is less than or equal to one of at least one remaining time threshold, and the remaining time is associated with PDCP discard timer.

Alternatively, in some implementations, the processor 1002 may be configured to operable to support a means for performing the following: transmitting, from a base station to a UE, at least one remaining time threshold for triggering reporting of at least one DSR; and receiving, from the UE, a first DSR among the at least one DSR, wherein the first DSR at least comprises a first sum of a first data volume of a first set of packets in a PDCP entity of the UE and a second data volume of a second set of packets in an RLC entity of the UE, remaining time of the first set of packets and the second set of packets is less than or equal to one of at least one remaining time threshold, and the remaining time is associated with PDCP discard timer.

The processor 1002 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1002 may be configured to operate a memory array using a memory controller. In some other implementations, a memory controller may be integrated into the processor 1002. The processor 1002 may be configured to execute computer-readable instructions stored in a memory (e.g., the memory 1004) to cause the device 1000 to perform various functions of the present disclosure.

The memory 1004 may include random access memory (RAM) and read-only memory (ROM). The memory 1004 may store computer-readable, computer-executable code including instructions that, when executed by the processor 1002 cause the device 1000 to perform various functions described herein. The code may be stored in a non-transitory computer-readable medium such as system memory or another type of memory. In some implementations, the code may not be directly executable by the processor 1002 but may cause a computer (e.g., when compiled and executed) to perform functions described herein. In some implementations, the memory 1004 may include, among other things, a basic I/O system (BIOS) which may control basic hardware or software operation such as the interaction with peripheral components or devices.

The I/O controller 1008 may manage input and output signals for the device 1000. The I/O controller 1008 may also manage peripherals not integrated into the device M02. In some implementations, the I/O controller 1008 may represent a physical connection or port to an external peripheral. In some implementations, the I/O controller 1008 may utilize an operating system such as iOS®, ANDROID®, MS-WINDOWS®, OS/2®, UNIX®, LINUX®, or another known operating system. In some implementations, the I/O controller 1008 may be implemented as part of a processor, such as the processor 1006. In some implementations, a user may interact with the device 1000 via the I/O controller 1008 or via hardware components controlled by the I/O controller 1008.

In some implementations, the device 1000 may include a single antenna 1010. However, in some other implementations, the device 1000 may have more than one antenna 1010 (i.e., multiple antennas), including multiple antenna panels or antenna arrays, which may be capable of concurrently transmitting or receiving multiple wireless transmissions. The transceiver 1006 may communicate bi-directionally, via the one or more antennas 1010, wired, or wireless links as described herein. For example, the transceiver 1006 may represent a wireless transceiver and may communicate bi-directionally with another wireless transceiver. The transceiver 1006 may also include a modem to modulate the packets, to provide the modulated packets to one or more antennas 1010 for transmission, and to demodulate packets received from the one or more antennas 1010. The transceiver 1006 may include one or more transmit chains, one or more receive chains, or a combination thereof.

A transmit chain may be configured to generate and transmit signals (e.g., control information, data, packets). The transmit chain may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmit chain may also include at least one power amplifier configured to amplify the modulated signal to an appropriate power level suitable for transmission over the wireless medium. The transmit chain may also include one or more antennas 1010 for transmitting the amplified signal into the air or wireless medium.

A receive chain may be configured to receive signals (e.g., control information, data, packets) over a wireless medium. For example, the receive chain may include one or more antennas 1010 for receive the signal over the air or wireless medium. The receive chain may include at least one amplifier (e.g., a low-noise amplifier (LNA)) configured to amplify the received signal. The receive chain may include at least one demodulator configured to demodulate the receive signal and obtain the transmitted data by reversing the modulation technique applied during transmission of the signal. The receive chain may include at least one decoder for decoding the processing the demodulated signal to receive the transmitted data.

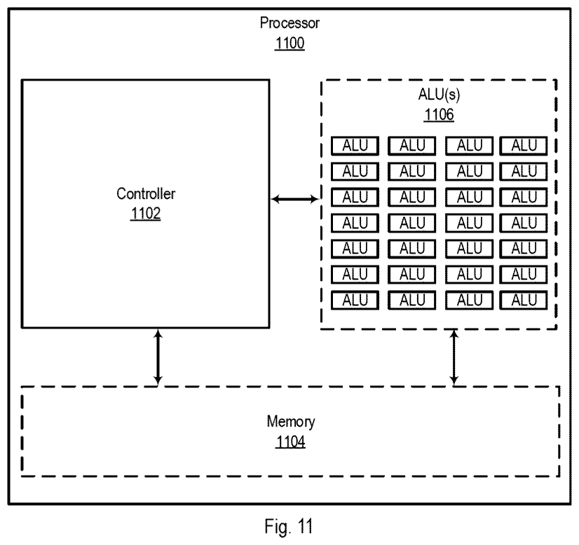

FIG. 11 illustrates an example of a processor 1100 that supports delay report and discarding based on a synchronization transmission set in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, such as L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory address of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, arithmetic logic units (ALUs), and other functional units of the processor 1100.

The memory 1104 may include one or more caches (e.g., memory local to or included in the processor 1100 or other memory, such RAM, ROM, DRAM, SDRAM, SRAM, MRAM, flash memory, etc. In some implementation, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, the controller 1102, and the memory 1104 may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementation, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. The processor 1100 may be configured to operable to support a means for performing the following: receiving, at a UE from a base station, at least one remaining time threshold for triggering reporting of at least one DSR; triggering the reporting of the at least one DSR based on the at least one remaining time threshold; and transmitting a first DSR among the at least one DSR to the base station, wherein the first DSR at least comprises a first sum of a first data volume of a first set of packets in a PDCP entity of the UE and a second data volume of a second set of packets in an RLC entity of the UE, remaining time of the first set of packets and the second set of packets is less than or equal to one of at least one remaining time threshold, and the remaining time is associated with PDCP discard timer.

Alternatively, in some implementations, the processor 1100 may be configured to operable to support a means for performing the following: transmitting, from a base station to a UE, at least one remaining time threshold for triggering reporting of at least one DSR; and receiving, from the UE, a first DSR among the at least one DSR, wherein the first DSR at least comprises a first sum of a first data volume of a first set of packets in a PDCP entity of the UE and a second data volume of a second set of packets in an RLC entity of the UE, remaining time of the first set of packets and the second set of packets is less than or equal to one of at least one remaining time threshold, and the remaining time is associated with PDCP discard timer.

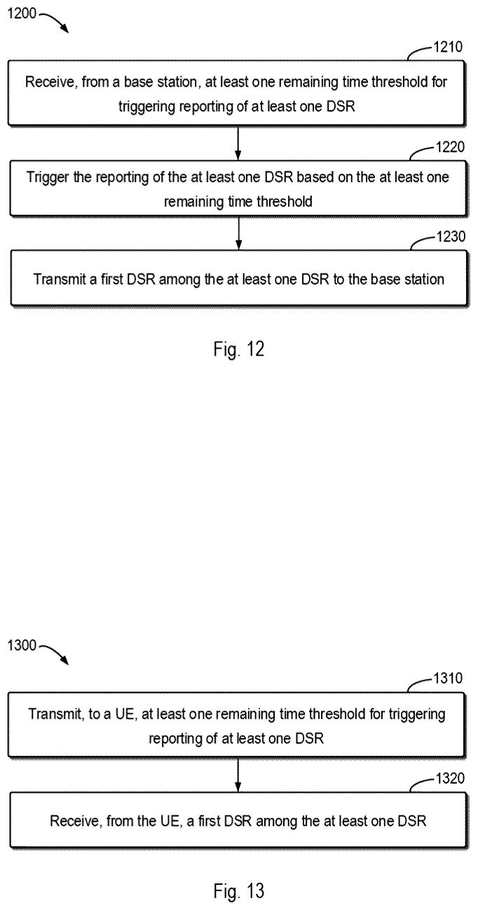

FIG. 12 illustrates a flowchart of a method 1200 that supports reporting of a DSR in accordance with aspects of the present disclosure. The operations of the method 1200 may be implemented by a device or its components as described herein. For example, the operations of the method 1200 may be performed by a UE 104 as described herein. In some implementations, the device may execute a set of instructions to control the function elements of the device to perform the described functions. Additionally, or alternatively, the device may perform aspects of the described functions using special-purpose hardware.

At 1210, the method may include receiving, at a UE from a base station, at least one remaining time threshold for triggering reporting of at least one DSR. The operations of 1210 may be performed in accordance with examples as described herein. In some implementations, aspects of the operations of 1210 may be performed by a device as described with reference to FIG. 1.

At 1220, the method may include triggering the reporting of the at least one DSR based on the at least one remaining time threshold. The operations of 1220 may be performed in accordance with examples as described herein. In some implementations, aspects of the operations of 1220 may be performed by a device as described with reference to FIG. 1.

At 1230, the method may include transmitting a first DSR among the at least one DSR to the base station. The first DSR at least comprises a first sum of a first data volume of a first set of packets in a PDCP entity of the UE and a second data volume of a second set of packets in an RLC entity of the UE, remaining time of the first set of packets and the second set of packets is less than or equal to one of at least one remaining time threshold, and the remaining time is associated with PDCP discard timer. The operations of 1220 may be performed in accordance with examples as described herein. In some implementations, aspects of the operations of 1220 may be performed by a device as described with reference to FIG. 1.

FIG. 13 illustrates a flowchart of a method 1300 that supports reporting of a DSR in accordance with aspects of the present disclosure. The operations of the method 1300 may be implemented by a device or its components as described herein. For example, the operations of the method 13 may be performed by a base station 102 as described herein. In some implementations, the device may execute a set of instructions to control the function elements of the device to perform the described functions. Additionally, or alternatively, the device may perform aspects of the described functions using special-purpose hardware.

At 1310, the method may include transmitting, from a base station to a UE, at least one remaining time threshold for triggering reporting of at least one DSR. The operations of 1310 may be performed in accordance with examples as described herein. In some implementations, aspects of the operations of 1310 may be performed by a device as described with reference to FIG. 1.

At 1320, the method may include receiving, from the UE, a first DSR among the at least one DSR. The first DSR at least comprises a first sum of a first data volume of a first set of packets in a PDCP entity of the UE and a second data volume of a second set of packets in an RLC entity of the UE, remaining time of the first set of packets and the second set of packets is less than or equal to one of at least one remaining time threshold, and the remaining time is associated with PDCP discard timer. The operations of 1320 may be performed in accordance with examples as described herein. In some implementations, aspects of the operations of 1320 may be performed by a device as described with reference to FIG. 1.

It shall be noted that implementations of the present disclosure which have been described with reference to FIGS. 2 to 9 are also applicable to the device 1000, the processor 1100 and the methods 1200 and 1300.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive, from a base station, at least one remaining time threshold for triggering reporting of at least one delay status report (DSR);
trigger the reporting of the at least one DSR based on the at least one remaining time threshold; and
transmit a first DSR among the at least one DSR to the base station, wherein the first DSR comprises at least a first sum of a first data volume of a first set of packets in a packet data convergence protocol (PDCP) entity of the UE and a second data volume of a second set of packets in a radio link control (RLC) entity of the UE, wherein a remaining time of the first set of packets and the second set of packets is less than or equal to the at least one remaining time threshold, and the wherein the remaining time is associated with a PDCP discard timer.

2. The UE of claim 1, wherein the first set of packets comprises:
PDCP service data units (SDUs) for which no PDCP protocol data units (PDUs) have been constructed, where a remaining time of is less than or equal to a first remaining time threshold among the at least one remaining time threshold, or
PDCP PDUs that have not been submitted to lower layers of the PDCP entity, where a remaining time is less than or equal to the first remaining time threshold; and
wherein the second set of packets comprises:
radio link control (RLC) SDUs and RLC SDU segments that have not been included in an RLC PDU, where a remaining time is less than or equal to the first remaining time threshold, or
RLC PDUs that are pending for initial transmission, where a remaining time is less than or equal to the first remaining time threshold.

3. The UE of claim 1, wherein the at least one processor is configured to trigger the reporting of the first DSR by:
based on determining that remaining time of a third set of packets is less than or equal to the one of the at least one remaining time threshold, triggering the reporting of the first DSR, wherein the third set of packets at least comprises the first set of packets and the second set of packets.

4. The UE of claim 3, wherein the remaining time of the third set of packets is the smallest remaining time among remaining times of the packets in the third set of packets.

5. The UE of claim 3, wherein the third set of packets comprises:
PDCP service data units (SDUs) for which no PDCP protocol data units (PDUs) have been constructed,
PDCP PDUs that have not been submitted to lower layers of the PDCP entity,
radio link control (RLC) SDUs and RLC SDU segments that have not been included in an RLC PDU,
RLC PDUs that are pending for initial transmission, or
RLC PDUs that are pending for retransmission.

6. The UE of claim 3, wherein the at least one processor is configured to trigger the reporting of the first DSR by the PDCP entity; and
wherein the at least one processor is further configured to cause the UE to:
provide the first data volume of the first set of packets from the PDCP entity to a media access control (MAC) entity of the UE; and
provide the second data volume of the second set of packets from the RLC entity to the MAC entity.

7. The UE of claim 6, wherein the at least one_processor is further configured to cause the UE to:
provide, from the PDCP entity to at least one of the RLC entity or the MAC entity, an indication indicating that the reporting of the first DSR is triggered.

8. The UE of claim 6, wherein the at least one processor is further configured to cause the UE to:
receive, from the base station, an indication indicating that all protocol data units (PDUs) in a PDU Set are to be discarded if any of the PDUs is not transmitted to the base station successfully; and
the first sum comprises a data volume of all the PDUs in the PDU Set to be transmitted when a remaining time of any of the PDUs in the PDU Set is less than or equal to the one of the at least one remaining time thresholds.

9. The UE of claim 3, wherein the at least one remaining time threshold comprises at least a first remaining time threshold and a second remaining time threshold greater than the first remaining time threshold; and
wherein the at least one processor is configured to cause the UE to trigger the reporting of the first DSR by one of the PDCP entity, the RLC entity, or a media access control (MAC) entity of the UE; and
wherein the processor is further configured to cause the UE to:
provide the first data volume of the first set of packets and a third data volume of a third set of packets in the PDCP entity from the PDCP entity to the MAC entity, wherein a remaining time of the first set of packets is less than or equal to the first remaining time threshold, and a remaining time of the third set of packets is greater than the first remaining time threshold and less than or equal to the second remaining time threshold; and
provide the second data volume of the second set of packets and a fourth data volume of a fourth set of packets in the RLC entity from the RLC entity to the MAC entity, wherein a remaining time of the second set of packets is less than or equal to the first remaining time threshold, and a remaining time of the fourth set of packets is greater than the first remaining time threshold and less than or equal to the second remaining time threshold; and
the first DSR comprises the first sum of the first data volume and the second data volume and comprises a second sum of the third data volume and the fourth data volume.

10. The UE of claim 3, wherein the at least one processor is configured to cause the UE to trigger the reporting of the first DSR by a media access control (MAC) entity of the UE.

11. The UE of claim 3, wherein the at least one processor is further configured to cause the UE to:
receive, from the base station, an indication indicating that all protocol data units (PDUs) in a PDU Set are to be discarded if any of the PDUs is not transmitted to the base station successfully; and
the third set of packets comprise a PDCP service data unit (SDU) that is first arrived at the PDCP entity and has been transmitted to the base station successfully or has been submitted to a media access control (MAC) entity of the UE, wherein a PDU associated with the PDCP SDU is within the PDU Set if any of the PDUs in the PDU Set belongs to the first set of packets or the second set of packets.

12. The UE of claim 1, wherein the at least one processor is configured to cause the UE to trigger the reporting of the first DSR by:
based on determining that remaining time of the first set of packets is less than or equal to the one of the at least one remaining time threshold, triggering the reporting of the first DSR by the PDCP entity; or
based on determining that remaining time of the second set of packets is less than or equal to the one of the at least one remaining time threshold, triggering reporting of a second DSR among the at least one DSR by the RLC entity; and
wherein the at least one processor is further configured to cause the UE to:
provide the first data volume of the first set of packets from the PDCP entity to a media access control (MAC) entity of the UE; and
provide the second data volume of the second set of packets from the RLC entity to the MAC entity.

13. The UE of claim 3, wherein the at least one remaining time threshold comprises a first remaining time threshold associated with a value of PDU Set Importance (PSI); and
wherein the at least one processor is configured to cause the UE to trigger the reporting of the first DSR by:
based on determining that a remaining time of at least one PDU Set with the value of PSI is less than or equal to the first remaining time threshold, triggering the reporting of the first DSR, wherein the at least one PDU Set is within the third set of packets.

14. The UE of claim 13, wherein the first sum comprises a data volume of the at least one PDU Set with the value of PSI.

15. The UE of claim 1, wherein the at least one processor is further configured to cause the UE to:
determine the first sum of the first data volume and the second data volume when the reporting of the first DSR is triggered or at the time of transmission of the first DSR.

16. The UE of claim 1, wherein the at least one processor is further configured to cause the UE to:
provide a request for the first data volume from a media access control (MAC) entity of the UE to the PDCP entity.

17. The UE of claim 1, wherein the at least one processor is further configured to cause the UE to:
provide a request for the second data volume from a media access control (MAC) entity of the UE to the RLC entity.

18. A base station for wireless communication, comprising:
at least one memory; and
at least one processor coupled with the at least one memory and configured to cause the base station to:
transmit, to a user equipment (UE), at least one remaining time threshold for triggering reporting of at least one delay status report (DSR); and
receive, from the UE, a first DSR among the at least one DSR, wherein the first DSR comprises at least a first sum of a first data volume of a first set of packets in a packet data convergence protocol (PDCP) entity of the UE and a second data volume of a second set of packets in a radio link control (RLC) entity of the UE, wherein a remaining time of the first set of packets and the second set of packets is less than or equal to one of at least one remaining time threshold, and the remaining time is associated with a PDCP discard timer.

19. A processor for wireless communication, comprising:
a controller coupled with the at least one memory and configured to cause the controller to:
receive, from a base station, at least one remaining time threshold for triggering reporting of at least one delay status report (DSR);
trigger the reporting of the at least one DSR based on the at least one remaining time threshold; and
transmit a first DSR among the at least one DSR to the base station, wherein the first DSR comprises at least a first sum of a first data volume of a first set of packets in a packet data convergence protocol (PDCP) entity of the UE and a second data volume of a second set of packets in a radio link control (RLC) entity of the UE, wherein a remaining time of the first set of packets and the second set of packets is less than or equal to one of at least one remaining time threshold, and wherein the remaining time is associated with a PDCP discard timer.

20. A method performed by a user equipment (UE), the method comprising:
receiving, from a base station, at least one remaining time threshold for triggering reporting of at least one delay status report (DSR);
triggering the reporting of the at least one DSR based on the at least one remaining time threshold; and
transmitting a first DSR among the at least one DSR to the base station, wherein the first DSR comprises at least a first sum of a first data volume of a first set of packets in a packet data convergence protocol (PDCP) entity of the UE and a second data volume of a second set of packets in a radio link control (RLC) entity of the UE, wherein a remaining time of the first set of packets and the second set of packets is less than or equal to one of at least one remaining time threshold, and wherein the remaining time is associated with a PDCP discard timer.
